(19) United States
(12) Patent Application Publication
(10) Pub. No.: US 2007/0028290 A1
(43) Pub. Date: Feb. 1, 2007

(54) Method and device for timeshifting using external memory card

(75) Inventor: Tan Dadurian, San Jose, CA (US)

Correspondence Address: ESS TECHNOLOGY, INC;C/O HAYNES BEFFEL & WOLFELD LLP, P.O. BOX 366, HALF MOON BAY, CA, 94019, US

(73) Assignee: ESS Technology, Inc., Fremont, CA (US)

(21) Appl. No.: 11/377,150

(22) Filed: Mar. 16, 2006

Related U.S. Application Data
(63) Continuation of application No. 11/191,336, filed on Jul. 28, 2005, now abandoned.

(51) Int. Cl. H04N 7/16; H04N 7/173

(52) U.S. Cl. 725/142; 725/134

(57) ABSTRACT

The present invention relates to timeshifting of program content. In particular, it relates to using an external memory element, thereby reducing the cost of the device that uses timeshifting.

### PRIORITY INFORMATION

This application is a continuation-in-part of U.S. patent application Ser. No. 11/191,336 entitled “Method and Device for Timeshifting Using External Memory Card” filed on 28 Jul. 2005 by Tan Dadurian.

### BACKGROUND OF THE INVENTION

The present invention relates to timeshifting of program content. In particular, it relates to using an external memory element, thereby reducing the cost of the device that uses timeshifting.

TiVo and digital video recorders (DVR) have made quite a splash in the market, even more so than VHS players that preceded them. There is a proven market for timeshifting of multimedia program content.

A limitation on incorporation of timeshifting into televisions and similar commodity consumer electronics is the cost of memory to implement time shifting. Popular DVR devices use rotating hard disk memory. Current production hard disks have a minimum unit cost. Instead of the cost of hard disks diminishing over time, their capacity has typically increased, maintaining a unit cost of around forty dollars. This cost and the complexity of a hard disk make it impractical to include timeshifting in commodity televisions.

An opportunity arises to develop an alternative memory configuration, that relieves the consumer electronic manufacturer of incorporating timeshifting memory in to a commodity device. Less expensive and more readily received components and systems may result.

### SUMMARY OF THE INVENTION

The present invention relates to timeshifting of program content. In particular, it relates to using an external memory element, thereby reducing the cost of the device that uses timeshifting. Particular aspects of the present invention are described in the claims, specification and drawings.

### BRIEF DESCRIPTION OF THE DRAWINGS

FIG. 1 is a block diagram of components that enable a television manufacturer to utilize external memory for timeshifting.

FIG. 2 is an alternative block diagram of components that enable a television manufacturer to utilize external memory for timeshifting.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

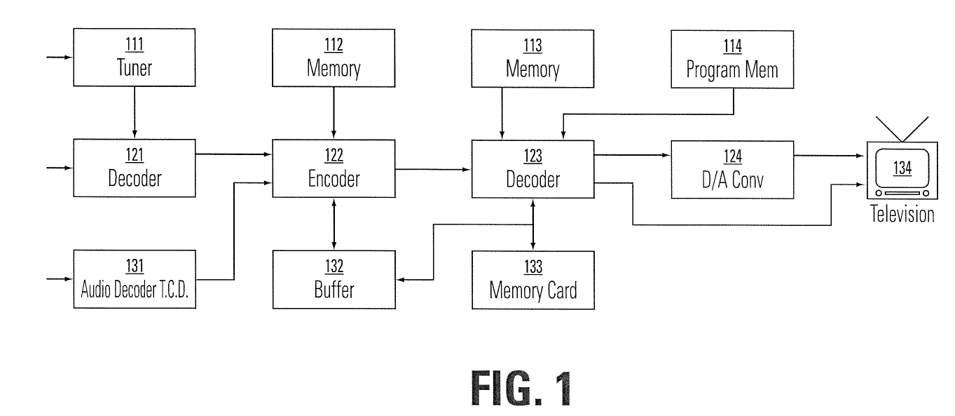

FIG. 1 is a block diagram of components that enable a television manufacturer to utilize external memory for timeshifting. This approach may make it practical to build timeshifting into consumer electronics that otherwise could not bear the cost of timeshifting memory. Many consumers have memory cards for their cameras or PDAs that are lightly used. These memory cards come in a variety of formats, including CompactFlash Card type I, CompactFlash Card type II, Memory Stick, Memory Stick PRO, Microdrive, MultiMediaCard, SD Memory Card, SmartMedia Card and XD Memory. These memories are credit card size or smaller (postage stamp sized for MultiMedia, SD and XD memories), removable and non-rotating, except the microdrives that are adapted to appear as CompactFlash devices. The non-rotating memories are typically variations on flash memory, but may in the near future use ferric memory or phase change memory. Future non-rotating memories are expected to have a longer life cycle, in terms of lifetime number of erase-write cycles, than flash memories. External memory is often available from the consumer, without incorporating its cost into a television.

In FIG. 1, radio frequency, video and audio inputs are accommodated. A TV tuner 111 accepts an RF input. A video/TV decoder 121 can accept a video input from an external source or from the tuner 111. The decoder 121 may be adapted to handle NTSC or PAL format (and variations on each) or both. An audio decoder is provided that can handle input from either the tuner 111 or an external source. Typically, the audio tuner is adapted to handle audio formats that accompany video signals, such as BTSC and/or Nicam and also may process other types of signals from other, external sources. In some configurations, digital input is received directly from another component, for instance an optical 7.1 or 5.1 audio feed.

Timeshifting of an analog source utilizes an encoder 122 and decoder 123 communicating with a memory card 133 where content is stored. In one embodiment, the encoder/decoder pair 122, 123 use MPEG encoding. The decoder may be the master and the encoder a slave, or vice-a-versa. In this context, timeshifting refers to buffering a program to permit breaks, delayed viewing or skipping sections. Timeshifting may apply to programs playing as the TV monitor is active or may apply to automatic recording of selected content. The encoder compresses the output of decoder 121, for instance decoded from NTSC or PAL format, into a digital recording-compatible format, such as MPEG 2 or 4. One encoder suitable for MPEG 2 compression is the ESS Technology, Inc. ES7010 and 7011 MPEG2 AV Encoder. These devices are MPEG 2 audio video encoders, including a video encode/transcode unit, audio DSP engine, a 32-bit RISC CPU, a video input/output unit and a system control unit. They use encoder memory 112, which may be located on a separate device, such as an 8 or 16 MB SDRAM memory, or may be integrated into a single component. Product sheets may be available on the ESSTech.com web site.

The decoder 123 may, for instance, be the ESS Technology, Inc. ES6698 Vibratto-II DVD Processor, which also supports control and progressive scan output from DVD media. The Vibratto II process is a highly integrated single chip DVD solution that integrates read channel, ECC, Servo DSP, MCU and MPEG 2/MPEG 4/DivX decoder to provide flicker-free video output and S/PDIF input and output support. It performs audio/video stream data processing, TV encoding, copy protection, DVD system navigation, system control and housekeeping functions. Product sheets may be available on the ESSTech.com web site. The Vibratto II processor is supported by decoder memory 113 and program storage 114, which may reside on separate devices or may be integrated into a single component. The decoder memory 113 may be an SDRAM. The program memory may be ROM, PROM, or other non-volatile memory.

While FIG. 1 illustrates an encoded signal passing through the decoder 123 before it reaches the memory card 133, for instance to be buffered in memory 113, the memory card 133 could alternatively be coupled directly to an encoder component 122.

An alternative component is the EX6425 Digital Media Processor 2, which is a high performance single-chip audio/video decoder with an onboard interface for flash memory media. It supports image processing of MPEG 1, MPEG 2 and MPEG 4 videos and JPEG photos. The ES6425 also performs audio processing for CD-DA, MP3, AAC and WMA playback. Again, a product sheet may be available online. The EX6425 may replace decoder 123, reducing the device count. An alternative component ES7020 can replace encoder 122, buffer 132 and decoder 123.

A digital-to-analog converter 124 is used to convert decoded audio into a signal that drives an analog speaker.

Using an external memory 133 and separating it from the time shifting logic enables manufacturing of a television 134, for instance, with low-cost timeshifting logic built in. The cost of components to build in the timeshifting logic is reduced by relying on separately purchased external memory.

The device depicted in FIG. 1 can be a television lacking sufficient memory for timeshifting or it can be a decoder coupled to a television or monitor, such as a satellite receiver or a cable receiver.

In operation, the encoder 122 can continuously direct content to the external memory 133, to allow the user to replay and review content from a recent time segment without missing current content of the live feed. Alternatively, it can be controlled in a VCR- or TiVo-like manner to record predetermined content, whether selected by channel or by program name. It also can be combined with Content Protection for Recordable Media (CPRM) logic or another media protection scheme.

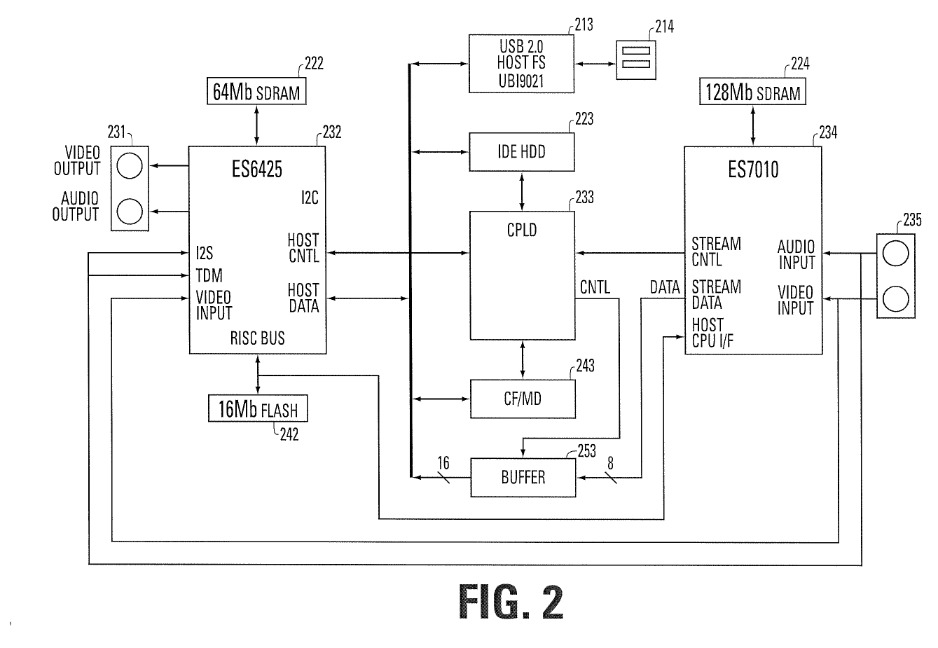

FIG. 2 depicts an alternative configuration, which is less abstract and more particularly tied to components. The audio and input jack 235 connect the encoder ES7010 circuit 234 and can bypass the encoder with a connection to the decoder ES6425 circuit 232, when content is not being time shifted. The encoder 234 uses an external volatile memory 224, which may be a 128 MB SDRAM. Alternatively, a encoder 234 could use another memory type or could have memory integrated into the encoder. The encoder 234 generates a control stream directed to a configurable programmable logic device (CPLD) 233 and a data stream directed to a buffer 253. The logic in the CPLD can be replaced in production with a custom device or could be integrated into anther device. The encoder 234 also may receive control signals from the decoder 232.

The CPLD connection logic 233 is in communication with a buffer 253 and a compact flash/micro drive reader 243. It may optionally be in communication with a rotating memory 223, such as an IDE HDD and with a general USB host adapter 213 that interfaces with a wide variety of USB-compatible memories 214. It provides logic to connect the encoder, decoder and memory components.

In this embodiment, storage of content on the memory card is handled by he decoder 232, due to its particular logical capabilities. Alternatively, this logic could be built into an encoder or intermediate logic. With the particular ESS components identified, the decoder 232 was chosen to control storage and retrieval of content from time shifting memory.

Time shifted content on a memory card is accessed through the card interface 243 or, optionally, on another memory type accessed through the IDE or USB interfaces 2,23, -213. The content is accessed on demand by the decoder. The decoder may be supported by external program memory 222, such as a 64MB SDRAM, and by program memory 242, such as a 16MB flash memory. The decoder provides video and audio output 231.

The present invention may be practiced as a method or device adapted to practice the method. It is contemplated that modifications and combinations will readily occur to those skilled in the art, which modifications and combinations will be within the spirit of the invention and the scope of the following claims.

We claim as follows:

1. An improved television with built-in time shifting logic, including:
one or more signal decoders that generate a multi-media signal from a live feed;
an external memory adapter;
a digital signal encoder, coupled to the signal decoder and in communication with the external memory adapter, the digital signal encoder being adapted to encode a multi-media signal in a form suitable to be stored on an external memory unit that engages with the external memory adapter;
a monitor and speaker adapted to reproduce multi-media content; and
a digital signal decoder, in communication with the external memory adapter and coupled to the monitor and speaker, the digital signal decoder adapted to decode multi-media content stored on the external memory unit;
wherein the external memory unit is optionally engaged with the external memory adapter to enable timeshifting of the live feed.

2. The improved television of claim 1, further including control logic controlling use of the external memory unit, when engaged, by the digital signal encoder.

3. The improved television of claim 1, further including control logic controlling use of the external memory unit, when engaged, by the digital signal decoder.

4. The improved television of claim 2, wherein the control logic further controls selection by the one or more signal decoders of multi-media content from the live feed.

5. The improved television of claim 2, wherein the control logic further controls the quality of the encoded multi-media signal on the external memory unit.

6. The improved television of claim 1, wherein the digital signal decoder is adapted to use an MPEG 4 format.

7. The improved television of claim 1, wherein the digital signal decoder is adapted to use a DIVX format.

8. The improved television of claim 1, wherein the digital signal decoder is adapted to use aVC1 format.

9. The improved television of claim 1, wherein the digital signal decoder is adapted to use a H.264 format.

10. A method of timeshifting in a device lacking sufficient built-in memory for timeshifting, including:
receiving a live feed of a multi-media signal including moving images;
decoding the live feed and selecting a particular multi-media signal;
engaging an external memory in an external memory adapter incorporated in the device lacking sufficient built-in memory for timeshifting;
encoding the particular multi-media signal into a digital format and recording the encoded multimedia signal onto the external memory;
at a later time, decoding the encoded multi-media signal from the external memory and viewing it on the device.

11. The method of claim 10, wherein the device is a television.

12. The method of claim 10, wherein the device is a satellite receiver.

13. The method of claim 10, wherein the device is a cable receiver.
